(19) United States
(12) Patent Application Publication
(10) Pub. No.: US 2026/0217134 A1
(43) Pub. Date: Jul. 30, 2026

(54) METHOD FOR DECELERATION OF AN ELECTRICALLY DRIVEN VEHICLE

(71) Applicant: Robert Bosch GmbH, Stuttgart (DE)

(72) Inventors: Laszlo Boros, Ludwigsburg (DE); Marcel Maier, Korntal-Muenchingen (DE); Simon Peter, Weil Der Stadt (DE)

(21) Appl. No.: 19/140,515

(22) PCT Filed: Dec. 5, 2023
(86) PCT No.: PCT/EP2023/084301

§ 371 Date: Jun. 18, 2025

(30) Foreign Application Priority Data
Dec. 20, 2022 (DE) 10 2022 214 086.9

(51) Int. Cl. B60L 15/20; B60L 3/00; B60L 7/24; B60L 7/28

(52) U.S. Cl. CPC B60L 15/2009; B60L 3/0061; B60L 7/24; B60L 7/28

(57) ABSTRACT

The invention relates to a method for deceleration of an electrically driven vehicle (10) having an electric drive train (12), which comprises at least one electric machine (14), an inverter (20), a high-voltage traction battery (46), at least one on-board electrical system (24), an eddy current brake (34, 36) and/or friction brakes (38), as well as at least one clutch (42), and the following method steps are carried out individually or in combination with one another:
a) feeding braking energy during deceleration of the electrically driven vehicle (10) into the electric drive train (12) thereof with the exception of the high-voltage traction battery (46), such that
b) an active short-circuit of the three phases of the electric machine (14) is generated by means of the inverter (20) and the braking energy is absorbed in the ohmic resistance of the windings; and/or
c) at high rotation speeds of the electric machine (14), the braking energy is fed into an eddy current brake (34, 36) and/or friction brake (38), and/or
d) when a maximum torque of the electric machine (14) is reached in the event of an active short-circuit (AKS), braking energy is fed into at least one slip-affected clutch (42) in the electric drive train (12).

### BACKGROUND

The invention relates to a method for deceleration of an electrically driven vehicle having an electric drive train comprising at least one electric machine, an inverter, a high-voltage traction battery, at least one on-board electrical system, an eddy current brake, and/or friction brakes. Furthermore, the invention relates to the use of the method in an electrically driven vehicle.

DE 10 2012 200 932 A1 relates to an apparatus and a method for actuating an electric machine arranged in a vehicle. The electric machine generates a torque acting on driven vehicle wheels. The electric machine has a phase path that is connectable to an energy store via an actuatable inverter. The inverter comprises a bridge circuit, wherein the phase path is associated with two switch paths and is connectable to the energy store such that the phase path current direction is reversible. Furthermore, there is a first sensing unit for sensing a chargeability state of the energy store and a second sensing unit for sensing a vehicle operating state characterized by a wheel braking torque. Depending on the charging capability state and the vehicle operating state, the inverter is driven in such a way that, when the vehicle operating state is present, the electric machine generates a braking torque acting on a driven wheel due to the phase-path current, wherein, as long as the chargeability state is different from a predefined state, actuation is done with a first driving pattern and the energy store is charged by the phase-path current, and as soon as the chargeability state corresponds to the predefined state, actuation is done with a second driving pattern, and the energy store is not charged by the phase-path current.

DE 10 2016 010 740A1 relates to the operation of a drive train by a short-circuit that is active in the short-term. In the electric drive train, there is provided an electric energy store, an inverter and an electric machine for driving a motor vehicle. An electrical connection between the inverter and the electrical energy store takes place as well as the initiation of an active short-circuit by short-circuiting a winding of the electrical machine as well as the determination of a current flow associated with the winding. In order to avoid the occurrence of both high voltages and high currents in the electric machine and/or the inverter when opening a disconnecting element, the active short-circuit of the winding is then interrupted when the current flow associated with it makes a zero pass.

### SUMMARY

In order for an overall system, at least a high-voltage traction battery, a battery management system, for example a 12-V electrical system, and a high-voltage on-board network as well as communication components, of an electrically driven vehicle to function properly, braking is usually done with the electric machine for decelerating the electric vehicle. However, if the overall system outlined is faulty, the electric machine cannot be braked, so that in this case, the friction brakes present on the vehicle absorb all of the accumulating braking energy. This can also occur in error-free situations, for example, if the temperature of the high-voltage battery is extremely low, this battery is already overcharged or too hot, i.e. has too high a temperature, or a charge of the battery in the context of recuperative brakes is not released due to momentary self-diagnosis being carried out by the battery management system, to name a few scenarios. In such situations, the high-voltage traction battery cannot receive a charging current that would be applied upon braking of the electric vehicle and fed into the high-voltage traction battery, or there is currently lacking reliable information for release in the inverter or power electronics in the electrical drive train of the electrically driven vehicle. As a result, braking with the electric drive cannot be performed in every driving situation, and the friction brakes mounted to the electrically driven vehicle must be further designed so as to absorb all of the braking energy in the worst-case scenario.

According to the present invention, a method for deceleration of an electrically driven vehicle is proposed, wherein the electrically driven vehicle comprises an electric drive train comprising at least one electric machine, an inverter, a high-voltage traction battery, at least one on-board electrical system, an eddy current brake, and/or friction brakes, with the following method steps, individually or in combination with one another:
feeding braking energy during deceleration of the electrically driven vehicle into the electric drive train thereof with the exception of the high-voltage traction battery, such that
an active short-circuit of the three phases of the electric machine is generated by means of the inverter and the braking energy is absorbed in the ohmic resistance of the windings; and/or
at high rotation speeds of the electric machine, the braking energy is fed into an eddy current brake and/or friction brake, and/or
when a maximum torque of the electric machine is reached in the event of an active short-circuit (AKS), braking energy is fed into at least one slip-affected clutch in the electric drive train.

With the solution proposed according to the invention, it can be advantageously achieved that the braking energy resulting from braking of the electric vehicle, which in the case of recuperation would be fed into the high-voltage traction battery, can now be absorbed into the components of the electric drive train and the inverter. The absorption of braking energy can be favored due to the fact that the thermal mass of the components installed in the electric drive train is relatively high and at least one of the components installed therein is often water-cooled.

In an advantageous further development of the method proposed according to the invention, the active short-circuit of the three phases on the electric machine is carried out continuously until the electrically driven vehicle comes to a stop or a clocking or subcircuit of the active short-circuit is carried out according to method step b), in that thermal dissipation loss is caused on switching elements.

In a further advantageous embodiment of the method proposed according to the invention, a maximum torque of about 50% of a rated torque is achieved at the operating point of the electric machine according to method step b).

In a further advantageous embodiment of the method proposed according to the invention, the braking torque of the electric machine is increased again according to method step c) by obtaining the energy required for driving the eddy current brake in the generator mode of the electric machine. Accordingly, no further separate circuit components or further components are required for a strengthening of the braking energy reduction; the absorption of the braking energy can only be provided with the components already installed in the electric drive train.

In the method proposed according to the present invention, the eddy current brake is coupled to the electric machine and is driven at its rotation speed. Due to the fact that the eddy current brake is driven at the engine rotation speed of the electric machine and not at the wheel rotation speed or the rotation speed of a cardan shaft, the eddy current brake can be made very compact and space-saving. Furthermore, an eddy current brake is characterized by its relatively low weight.

In an advantageous further development of the method proposed according to the invention, in the case of active short-circuit according to method step b), the electric machine has a rotation speed at which the maximum torque is present. A clutch can absorb a rotation speed difference.

In an advantageous further development of the method proposed according to the invention, a portion of the braking energy is converted by the slip occurring at said differential rotation speed. Again, the clutch can be used as a passive component that converts the braking energy, which is already arranged in the drive train of the electric machine.

In an advantageous further development of the method proposed according to the invention, the driver's braking request can be transmitted directly to the inverter via a VCU (Vehicle Control Unit) or via a driver assistance system, for example the ESP system, in such a way that a proportion of the braking energy attributable to the friction brakes of the electrically driven vehicle is previously determined.

Advantageously, in the method proposed according to the present invention, a number of brakings by means of the electric drive train or the high-voltage traction battery can be indicated to the driver of the electrically driven vehicle by means of a temperature model. As a result, an additional safety aspect can be generated, which is particularly advantageous for inexperienced drivers and may contribute to controlling an electrically driven vehicle to a significant extent.

In an advantageous embodiment of the method proposed according to the invention, if braking operations are not available, the velocity of the electrically driven vehicle can be limited and/or the vehicle can be turned off in a controlled manner after a braking has been performed.

Moreover, the invention relates to the use of the method in an electrically powered vehicle.

With the method proposed according to the present invention, the components of the electric drive train of an electrically driven vehicle can be used in order to absorb the braking energy, because their thermal mass is relatively high, and components in the electrical drive train of an electrically driven vehicle can be provided with cooling by a cooling medium. The solution proposed according to the invention takes into account the overall significantly increasingly important fact that recuperation energy generated during braking operations of an electrically driven vehicle can no longer be introduced into the high-voltage traction battery with the already fully charged high-voltage traction battery at too high a temperature, or in the case of self-diagnosis routines. With the method proposed according to the present invention, other components housed in the electric drive train of an electrically driven vehicle can be utilized in order to convert braking energy occurring during braking.

In the case of windings of the electric machine, their ohmic resistance is used in order to convert the braking energy, and switching components can be used, for example, on the inverter, where thermal dissipation loss is caused. Finally, the use of the eddy current brake can increase the braking torque of the electric machine in generator operation again. It should not go unmentioned that a slip-affected clutch provided in the drive train can also convert brake energy with the solution proposed according to the invention. One embodiment of a slip-affected clutch is given, for example, by a “twinster” clutch.

The solution proposed according to the present invention allows braking in a secure manner solely with the components of an electric drive train and the inverter present in the latter, even when the high-voltage traction battery or other components are faulty or in a state in which the absorption of recuperation energy accruing during braking, i.e. braking energy, is not possible. On the one hand, reliable availability of brakes is ensured by the solution proposed according to the invention, and on the other hand, the classical brake system with disc or drum brakes on the driven axles of a vehicle can be designed smaller and thus more cost-effectively and, above all, more weight-saving. Ideally, on the driven axle, i.e. the axle driven by the electric machine, the conventional mechanical brake can be omitted altogether.

The solution proposed according to the invention furthermore takes into account the circumstance that, in the event of a failure of a normal communication between the e-axis, battery management, and braking, electrical braking can still be carried out. On the one hand, this means that there is no secure information as to whether the high-voltage or traction battery can absorb charging current and also no reliable information as to whether a brake is to be used at all. If necessary, this would be from the brake system, which always specifies how much is to be braked with the friction brake and how much is to be electrically braked.

The solution proposed according to the invention can ensure that braking is carried out in such a way that no charging current is transmitted to the high-voltage or traction battery and in particular all possibilities are exploited, in particular the active short-circuit. Furthermore, an additional signal path from the brake pedal or from the brake request sensing module can be placed towards the e-axis so that it can brake even if normal communication with the brake system is erroneous. According to the solution proposed according to the invention, electrical braking can be performed, although the usual communication between a power electronics (inverter) and a braking system or between the inverter is erroneous. In conventional methods, the brakes are no longer electrically braked, but rather rely on the brake system on its own in order to overcome the travel situation without communication with the inverter.

### BRIEF DESCRIPTION OF THE DRAWINGS

The invention is described in greater detail below with reference to the drawings.

Shown are:

FIG. 1 is an electrically driven vehicle,

FIG. 2 braking torque curves of an electric machine, an eddy current brake, and an electric machine in the generator mode, and

FIG. 3 a perspective, partially-cut view of an e-axis module having driveshafts, a transmission, a slip-affected clutch, and an electric machine housed in a common housing.

### DETAILED DESCRIPTION

In the following description of the embodiments of the invention, identical or similar elements are denoted by identical reference signs, whereby a repeated description of these elements is omitted in individual cases. The drawings show the subject matter of the invention only schematically.

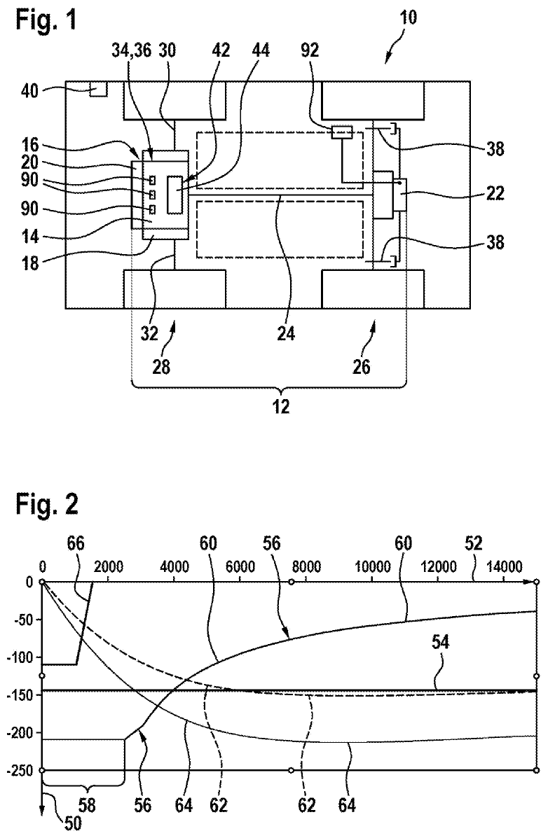

FIG. 1 shows an electrically driven vehicle 10 having an electric drive train 12, as well as the components arranged therein.

The electrically driven vehicle 10 according to the schematic representation shown in FIG. 1 comprises an electric drive train 12 comprising at least one electric machine 14. The at least one electric machine 14 is housed in a common housing 16, which also serves to receive a transmission 18. The electric machine 14 is associated with an inverter 20, wherein the inverter 20 is also referred to as the power electronics. The control of the electric drive train 12 or the electrically driven vehicle 10 is done via a vehicle VCU (VCU) 22. In the exemplary embodiment of the electrically driven vehicle 10 according to FIG. 1, the VCU 22 is housed in the front part of the vehicle 10 and associated with a front axle 26. In addition to the front axle 26, the electric drive train 12 also comprises a rear axle 28 realized by a first drive shaft 30 as well as a second drive shaft 32 driven by the at least one electric machine 14.

In addition, the electric drive train 12 has a central brake 34, which is preferably embodied as an eddy current brake 36. The rear axle 28 driven by the at least one electric machine 14 in the exemplary embodiment according to FIG. 1 does not comprise friction brakes 38 as arranged on the wheels of the front axle 26 in the illustration according to FIG. 1. The friction brakes 38 are also controlled via the VCU 22 of the electrically driven vehicle 10.

Furthermore, a charging port 40 is provided on the electrically driven vehicle 10, which can be located on a longitudinal side or also in the region of the trunk or front cover of the electrically driven vehicle 10. The electric machine 14 or its transmission 18 is associated with a clutch 42, which can replace, for example, a conventional differential transmission. The clutch 42 is realized as a slip-affected clutch and comprises meshing fin parts and can be configured as, for example, a “twinster” clutch 44.

In the bottom of the electrically driven vehicle 10 shown in the top plan view in FIG. 1, there is at least one high-voltage traction battery 46. The electrically driven vehicle 10 also comprises at least one on-board electrical system 24, which can be, for example, a high-voltage on-board electrical system. Furthermore, the electrically driven vehicle 10 comprises a further battery 48, for example at a voltage level of 12 V, which can represent a further on-board electrical system of the electrically driven vehicle 10.

If the electrically driven vehicle 10 shown in FIG. 1 is traveling with a fully charged high-voltage traction battery 46 or if the high-voltage traction battery 46 is at a very high temperature or the high-voltage traction battery 46 is in self-diagnosis mode, then it can not absorb braking energy during a braking operation or even during an emergency braking operation, which is recuperatively generated during braking in the electric machine 14 operated in the generator mode. According to the invention, it is provided that, in this case, the electric drive train 12, or the components present in it, absorb the braking energy. This, on the one hand, can ensure a reliable availability of braking operations with the electric drive train 12 and, on the other hand, a classical braking system on the drive axle in the present example according to FIG. 1 can be designed smaller, more weight-saving, and thus more cost-efficient or even omitted on the rear axle 28, for example. In the scenario described above, because braking energy can no longer flow towards the high-voltage traction battery 46, the braking energy is to be absorbed solely by the components of the electric drive train 12. The thermal mass of the components present in the electric drive train 12 is relatively high, wherein generally at least one of the components installed in the electric drive train 12 is provided with external cooling, for example water cooling.

If braking is performed as described above, a logic is activated in the inverter 20 such that the three phases of the electric machine 14 are short-circuited. As a result, the braking energy is absorbed into the ohmic resistance of the windings of the electric machine 14 without having to resort to other high-voltage components within the electric drive train 12. The short-circuit can be an active short-circuit that is performed continuously until the electrically driven vehicle 10 has come completely to a stop, which occurs within a few seconds. Alternatively, there is the possibility of the active short-circuit being performed in a clocked manner or as part of a subcircuit, so that switching elements 90 installed in the electric drive train 12 can cause thermal dissipation loss. With drive thus configured, a maximum torque of typically 50% of the rated torque can be achieved at the operating point of the electric machine 14 in case of an active short-circuit.

Such an absorption of the braking energy in the electric drive train 12 is achievable solely by the operational strategy shown in method step b), where an active short-circuit of the three phases of the electric machine 14 is generated by means of the inverter 20, and the braking energy is absorbed in the ohmic resistance of the windings of the electric machine 14.

If the braking torque applied by the electric machine 14 in the generator mode is not sufficient, which is usually the case at very high rotation speeds, then at very high rotation speeds the braking torque can also be provided by the central brake 34 as shown in the illustration of the electrically driven vehicle 10 by the eddy current brake 36. Advantageously, an eddy current brake 36 is employed, or a friction brake 38 is employed. In particular, the operating characteristic of an eddy current brake 36 is ideal for assisting the positioning of the braking torque in the electric drive train 12 of an electrically driven vehicle 10. An important feature of the eddy current brake 36 is that it does not rotate at the wheel rotation speed or at the rotation speed of a cardan or drive shaft, but rather at the engine rotation speed, i.e., the rotation speed of the electric machine 14. As a result, the eddy current brake 36, which acts as the central brake 34 integrated in the electric drive train 12 can be designed very compactly and thus with low weight and inexpensive.

Due to the fact that the eddy current brake 36 consumes power in operation, the braking torque of the electric machine 14 can thus be increased by recovering the power required to operate the eddy current brake 36 from the electric machine 14 when operating in the generator mode.

FIG. 2 shows the curves of torques of the electric machine 14 as well as the eddy current brake 36 in a standard manner or in booster operation.

In the illustration according to FIG. 2, a rotation speed curve 52 of the electric machine 14 is plotted. The brake torque request 50 is shown in the illustration according to FIG. 2 only in a negative range from 0 Nm to- 250 Nm. The depicted rotation speed curve 52 of the electric machine 14 extends from rotation speed 0 min⁻¹ to 14,000 min⁻¹.

From the comparison of the graphs shown in FIG. 2, it can be seen that in this example, a braking torque request 50 corresponding to a delay torque 54 is requested. In this case, the electric machine 14 provides a majority of the braking torque at a rotation speed of about 2,000 min⁻¹ according to the plateau 58 shown in FIG. 2, whereas the eddy current brake 36 is still nearly ineffective at relatively low rotation speeds of the electric machine 14. The braking torque imparted by the eddy current brake 36 runs according to the torque curves 62 for the eddy current brake 36, or according to an amplification mode 64 for the torque curve 62 of the eddy current brake 36. The latter amplification mode 64 represents an amplification of the torque curve 62 that defaults on the eddy current brake 36. From the illustration according to FIG. 2, it can be seen that the proportion of braking torque formed by the eddy current brake 36 increases with increasing rotation speeds, whereas, upon passing through the plateau 58, the torque curve 56 for the electric machine 14 experiences torque weakening 60 with increasing rotation speeds. The higher the rotation speed of the electric machine 14, the greater the weakening 60 of the braking torque portion provided by it. Reference numeral 66 denotes a torque curve of an electromechanical parking brake. This can optionally be installed in the vehicle 10 and can brake at low rotation speeds, particularly in the region where the eddy current brake 36 cannot provide torque.

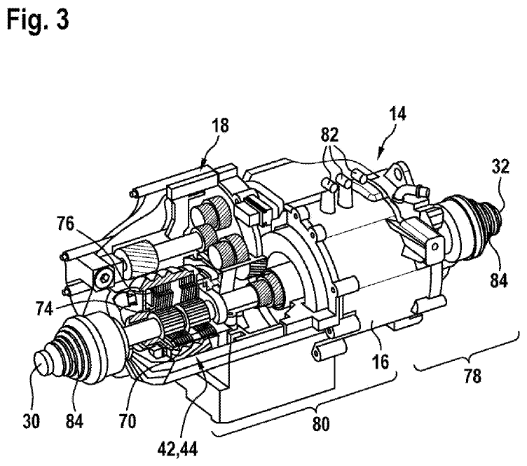

In the solution proposed according to the invention, the braking energy is not only converted according to method steps b) and c); rather, according to feature c) of the disclosure, when a maximum torque is reached in case of active short-circuit (AKS), a feeding of braking energy is performed into at least one slip-affected clutch 42 in the electric drive train 12. As a result, a “serial brake” can be realized. Because a pronounced maximum torque occurs when inducing an active short-circuit on the electric machine 14 between its phases, it can be exploited in order to calibrate the corresponding differential rotation speed in the case of a slip-affected clutch 42 installed in the electric drive train 12. As a result, some of the braking power is absorbed by the slip occurring within the clutch 42. For example, instead of a conventional differential, a “twinster” clutch 44 suggested in FIG. 3 can be employed, which is realized substantially by coupling fins 72, divided into a stationary fin group 74 and a rotating fin group 76.

In this context, FIG. 3 shows a perspective view of an e-axis module in which the electric machine 14 as well as the transmission 18 associated therewith, the inverter 20, and the slip-affected clutch 42 are accommodated in the common housing 16. On both sides of the common housing 16 shown in partial perspective view in FIG. 3, the two drive shafts 30, 32 extend to the wheels of the driven axle formed by the drive shafts 30, 32 not shown in FIG. 3. The slip-affected clutch 42 is integrated into the transmission 18 and is configured here as a “twinster” clutch 44, which assumes the function of a differential omitted here. Drive shafts 30, 32 are encapsulated via collars 84; common housing 16 comprises a transmission housing portion 80 and electrical connectors 82. The common housing 16 is further associated with the inverter 20, which is located, for example, below or above the common housing 16.

In the perspective view shown in FIG. 3, the slip-affected clutch 42 comprises clutch fins 72, of which a steady-state fin group 74 is located on the rotating components, i.e. on the axle parts driven by the electric machine 14, whereas a rotating fin group 76 is located within the clutch housing of the slip-affected clutch 42. A conventional differential transmission is replaced by the clutch 42 shown schematically in FIG. 3.

According to the solution proposed according to the invention, there is provided a possibility for deceleration of an electrically driven vehicle 10, which utilizes the components of the electric drive train 12 of the electrically driven vehicle 10 in order to absorb braking energy. The braking energy can be distributed according to several strategies, wherein initially an active short-circuit of the three phases of the electric machine 14 is generated by means of the inverter 20, wherein the braking energy is absorbed into the ohmic resistance of the windings. A relatively high proportion of the braking energy can thus already be accommodated. Taking into account high rotation speeds of the electric machine 14, according to a further aspect of the solution proposed according to the invention, the braking energy that can no longer be provided in the charged high-voltage traction battery 46 is fed into an eddy current brake 34, 36 and/or to friction brakes 38 and converted there substantially into heat.

Finally, a slip-affected clutch 42 housed in the electric drive train 12 of the electrically driven vehicle 10 can degrade and also convert into heat due to slip. Thus, in the exceptional scenario described above relating to a high-voltage traction battery 46 that is not ready for absorption of braking energy, either because it is fully charged or because it is at too high a temperature, or because it is in the self-diagnosis mode, it is ensured that the braking energy can be converted to the relatively high thermal mass components in the electric drive train 12.

The inverter 20 receives the braking request from either the VCU 22 or the ESP system. Typically, the proportion that is provided by the friction brakes 38 located on the front axle 26 of the electrically driven vehicle 10, as shown in FIG. 1, is already determined. Alternatively, the inverter 20 can also directly read the braking request via a brake pedal 92 itself. This has the advantage that the inverter 20 can also initiate braking operations when communication with other components in the electric drive train 12 is erroneous. An over-braking is then prevented even without driving dynamics information from the ESP system by observing the delay via the engine rotation speed. In the above scenario, a recuperative braking is not possible, so that the braking energy or the braking torque is converted by the above-mentioned components according to the method steps b), c), and d). The braking torque is divided between the active short-circuit and, if present, the braking elements, in particular the eddy current brake 36, acting as the central brake 34. In the case of the active short-circuit, the drive is modulated according to the braking request and the power distribution. For example, a complete short-circuit or, as indicated in method step b), a clocking or subcircuit can be performed.

A further aspect of the solution proposed according to the present invention is that the availability of braking operations via the electric drive train 12 can be determined via a temperature model. The velocity of the electrically driven vehicle 10 can be limited, or if braking operations are no longer sufficient, the electrically driven vehicle 10 can be safely turned off after a controlled braking. However, the active short-circuit phases are typically configured so as to enable continuous operation.

The invention is not limited to the exemplary embodiments described herein and the aspects highlighted thereby. Rather, within the range specified by the disclosure, a plurality of modifications is possible, which lie within the abilities of a skilled person.

1. A method for deceleration of an electrically driven vehicle (10) having an electric drive train (12), which comprises at least one electric machine (14), an inverter (20), a high-voltage traction battery (46), at least one on-board electrical system (24), an eddy current brake (34, 36) and/or friction brakes (38), the method comprising, individually or in combination with one another:
a) feeding braking energy during deceleration of the electrically driven vehicle (10) into the electric drive train (12) thereof with the exception of the high-voltage traction battery (46), such that
b) an active short-circuit of the three phases of the electric machine (14) is generated by means of the inverter (20) and the braking energy is absorbed in the ohmic resistance of the windings; and/or
c) at high rotation speeds of the electric machine (14), the braking energy is fed into an eddy current brake (34, 36) and/or friction brakes (38), and/or
d) when a maximum torque of the electric machine (12) is reached in the event of an active short-circuit (AKS), braking energy is fed into at least one slip-affected clutch (42) in the electric drive train (12).

2. The method according to claim 1, wherein, according to method step b), the active short-circuit of the three phases on the electric machine (14) is continuously performed until the electrically driven vehicle (10) comes to a stop or
a clocking or subcircuit of the active short-circuit according to method step b) is carried out in such a way that a thermal dissipation loss is caused on switching elements.

3. The method according to claim 1, wherein, according to method step b), when the short-circuit (AKS) is active, a maximum torque of about 50% of a rated torque is achieved in the operating point of the electric machine (14).

4. The method according to claim 1, wherein, according to method step c), the braking torque of the electric machine (14) is increased again by obtaining the energy required for driving the eddy current brake (34, 36) in the generator mode of the electric machine (14).

5. The method according to claim 1, wherein the eddy current brake (34, 36) is coupled to the electric machine (14) and driven at its rotation speed.

6. The method according to claim 1, wherein, in the event of a maximum torque generated according to method step b) during an active short-circuit, at least one clutch (42) installed in the electric drive train (12) absorbs the rotation speed difference corresponding to the maximum torque.

7. The method according to claim 6, wherein a portion of the braking energy is converted due to the occurring slip at the differential rotation speed.

8. The method according to claim 1, wherein the braking request is transmitted to the inverter (20) either via a VCU 22 or from a driver assistance system, in such a way that a portion of the braking energy attributable to the friction brakes (38) is already removed from the equation.

9. The method according to claim 1, wherein, by means of a temperature model, an availability of braking by means of the electric drive train (12) or the high-voltage traction battery (46) is indicated to the driver of the electrically driven vehicle (10).

10. The method according to claim 9, wherein, when braking operations are not available, the velocity of the electrically driven vehicle (10) is limited and/or the vehicle (10) is turned off in a controlled manner after a braking has been performed.

11. A use of the method according to claim 1, in an electrically driven vehicle (10).
